(19) United States
(12) Patent Application Publication
(10) Pub. No.: US 2022/0218157 A1
(43) Pub. Date: Jul. 14, 2022

(54) FOOD ARTICLE CUTTING BOARD AND RELATED METHOD

(71) Applicant: Earl Carter, Dearborn Heights, MI (US)

(72) Inventor: Earl Carter, Dearborn Heights, MI (US)

(21) Appl. No.: 17/707,417

(22) Filed: Mar. 29, 2022

Related U.S. Application Data
(63) Continuation-in-part of application No. 16/797,743, filed on Feb. 21, 2020, now abandoned.
(60) Provisional application No. 62/837,775, filed on Apr. 24, 2019.

(51) Int. Cl. A47J 47/00; B26D 1/30; B26D 5/10; B26D 7/20; B26D 7/22

(52) U.S. Cl. CPC A47J 47/005; B26D 1/30; B26D 5/10; B26D 2007/0018; B26D 7/225; B26D 2210/02; B26D 7/20

(57) ABSTRACT

A cutting board for cutting food articles into parts. The cutting board has a pair of long sides and a pair of short sides defining an area of the cutting board. A lateral groove extends between the pair of long sides and differentiates the area of the board into a first platform and a second platform. The area is further differentiated into a third platform which is adjacent to the second platform. A blade pivotally coupled to the end of the lateral groove. The cutting board further includes a finger guard and a food stopper.

### CROSS-REFERENCE TO RELATED APPLICATIONS

This application is a continuation-in-part of a U.S. patent application Ser. No. 16/797,743, filed on Feb. 21, 2020, which claims priority from the U.S. Provisional Patent Application No. 62/837,775 filed Apr. 24, 2019, both of which are incorporated herein by reference in its entirety.

### FIELD OF INVENTION

The present invention relates to an apparatus and method for cutting food articles, and more particularly, relates to an apparatus for facilitating cutting off vegetables into parts.

### BACKGROUND

Food is essential for life and the preparation of food involves the step of cutting down raw food, such as vegetables into pieces that can be cooked. Food articles herein refer to both plant and animal products including fruits and vegetables. A knife is a vital and usually used tool for cutting food articles into pieces. Be it home cooking or professional cooking, knives are used to cut food articles into parts. Cutting food articles using a knife is a skill and mishandling a knife can cause injuries. Moreover, the skill of cutting food articles includes cutting the food articles into consistent-sized parts. Consistent-sized parts of food articles have an aesthetic appearance and are convenient to eat, cook or handle. The skill of food cutting using a knife, like any other skill, improves with practice.

However, knife-related injuries while cutting food articles are also quite common. Beginners who have just started using the knife for food cutting are more susceptible to getting injured by the knife. Still, it is common that a skilled person may also sometimes mishandles the knife and get injured. This happens when a person losses focus while cutting the food articles or is cutting the food articles in bulk. Aged people with declining fine motor skills usually find it difficult and dangerous to work with knives. The fine motor skills of a person can get affected by age, disease, or disorder. Besides the risk of injury, cutting off the consistent size parts can be a daunting task for people with declining fine motor skills.

Thus, a long-felt need is there for an apparatus that may permit cutting down food articles into parts more safely than a knife. In particular, a long-felt need is there for an apparatus that allows people with declining fine motor skills to safely cut the food articles into consistently sized parts.

### SUMMARY OF THE INVENTION

The principal objective of the present invention is therefore directed to a cutting board for food articles that addresses one or more problems of using knives for cutting food articles.

It is an additional objective of the present invention that a novice can safely and efficiently use the cutting board.

It is a further objective of the present invention that the cutting board can be safely used by people with declining motor skills.

It is another objective of the present invention that the cutting board allows cutting off food articles into consistently sized parts.

Yet another objective of the present invention is that the cutting board is economical to manufacture and easier to use.

In one aspect, disclosed is a cutting board for cutting food articles into parts, the cutting board having a first short side, a second short side, a first long side, and a second long side defining an area of the board, the area of board differentiated into a first platform, a second platform, and a third platform, the first platform is adjacent to the first short side, the second platform is adjacent to the first platform, and the third platform is adjacent to the second platform, the first platform and the second platform are co-planar, the third platform slopes downwards towards the second short side forming a ramp. The third platform can be removably coupled to the second platform. A lateral groove that extends between the first long side and the second long side, the lateral groove configured between the first platform and the second platform, the lateral groove is having a first end and an opposite second end; and a blade has a proximal end and a distal end, the proximal end pivotally coupled to the first end of the lateral groove and the distal end configured with a handle.

In another aspect, the cutting board further comprises a finger guard coupled to the first platform adjacent to the lateral groove, the finger guard having a front opening and a rear opening defining a passageway, the passageway configured to permit a food article to pass through. The finger guard can be removably coupled to the first platform, wherein a plurality of male members can be configured at the underside of the finger guard and the cutting board can be configured with corresponding female members, the male members mate with the female members. In one case, the male members are protrusions, and the female members are grooves, the protrusion snaps into the grooves.

In another aspect, the cutting board further comprises a food stopper mounted to the second platform adjacent to the lateral groove, the food stopper configured to restrict the movement of a food article being cut off to cut the food article into similar sized parts. The food stopper can be removably coupled to the cutting board, wherein the distance of the food stopper from the lateral groove can be varied. To vary the distance between the lateral groove and the food stopper, a plurality of female attachments spaced apart at distances from the lateral groove can be disposed in the cutting board. The food stopper can be attached to one of the plurality of female attachments.

In another aspect, the cutting board is rectangular having the first-long side and the second-long side parallel to one another and the first short side and the second short side parallel to one another and perpendicular to the first long side.

These and other objects and advantages of the embodiments herein will become readily apparent from the following detailed description taken in conjunction with the accompanying drawings.

### BRIEF DESCRIPTION OF THE DRAWINGS

The accompanying figures, which are incorporated herein, form part of the specification and illustrate embodiments of the present invention. Together with the description, the figures further explain the principles of the present invention and to enable a person skilled in the relevant arts to make and use the invention.

FIG. 1 is a top and right perspective view of a cutting board, according to a preferred embodiment of the present invention; and,

FIG. 2 is a top and left perspective view of the cutting board of FIG. 1, according to a preferred embodiment of the present invention.

FIG. 3 shows an exploded view of the cutting board as shown in FIG. 1, according to an exemplary embodiment of the present invention.

FIG. 4 is a flowchart illustrating a method for cutting the food article, according to an exemplary embodiment of the present invention.

FIG. 5 is a perspective view of another embodiment of the cutting board, according to an exemplary embodiment of the present invention.

FIG. 6 is a top view of the cutting board of FIG. 5, according to an exemplary embodiment of the present invention.

FIG. 7 is a side view of the cutting board of FIG. 5, according to an exemplary embodiment of the present invention.

FIG. 8 is a front view of the cutting board of FIG. 5, according to an exemplary embodiment of the present invention.

FIG. 9 is a perspective view of a finger guard of the cutting board, according to an exemplary embodiment of the present invention.

FIG. 10 is a front view of a finger guard of the cutting board, according to an exemplary embodiment of the present invention.

FIG. 11 is a side view of a finger guard of the cutting board, according to an exemplary embodiment of the present invention.

FIG. 12 is a top view of the cutting board, showing a layout of the apertures for mounting the food stopper, according to an exemplary embodiment of the present invention.

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, the reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is for the purpose of describing particular embodiments only and is not intended to be limiting of embodiments of the invention. As used herein, the singular forms “a”, “an”, and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

All the implementations described below are exemplary implementations provided to enable persons skilled in the art to make or use the embodiments of the disclosure and are not intended to limit the scope of the disclosure, which is defined by the claims.

The following detailed description includes the best currently contemplated mode or modes of carrying out exemplary embodiments of the invention. The description is not to be taken in a limiting sense but is made merely for the purpose of illustrating the general principles of the invention since the scope of the invention will be best defined by the allowed claims of any resulting patent.

The present invention is directed to a cutting board for food articles, such as vegetables, fruits, and meat products. More particularly, the disclosed cutting board can be used to cut even-sized pieces of leafy vegetables, such as collard greens and mustard greens. The disclosed cutting board has a finger guard that can protect the fingers of the user while cutting the food articles, more particularly cutting vegetables, and more particularly cutting the leafy vegetables.

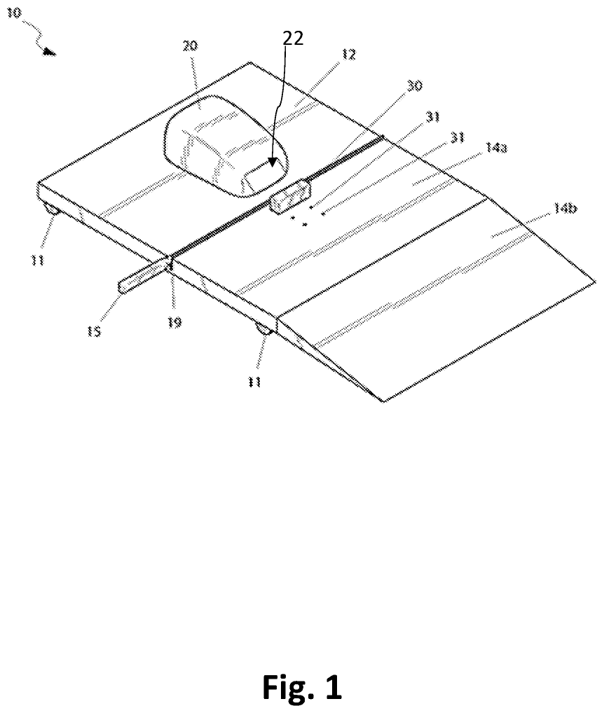

Referring to FIG. 1, which shows an exemplary embodiment of the cutting board 10, according to the present invention. The cutting board 10 shown in FIG. 1 is of a rectangular configuration having a pair of long sides that are parallel to one another and a pair of short sides that are parallel to one another and perpendicular to the longer sides. It will be appreciated that the above rectangular-shaped cutting board 10 is a preferred embodiment, however, the cutting board 10 can be embodied in any other shape without departing from the scope of the present invention. For example, in one case, the corners of the cutting board 10 can be rounded. In another case, one of the edges of the cutting board 10 can be rounded. The cutting board 10 can be made of any food-compatible rigid material, known to a skilled person for use in kitchen utensils and articles. In a preferred embodiment, the cutting board 10 can be made of wood or plastic that allows the disclosed cutting board to be washed. The material of the cutting board can be durable that can at least withstand repeated blunt forces applied thereto without cracking or splintering.

The cutting board 10, as shown in FIG. 1, can be differentiated into three distinct portions, first platform 12, second platform 14a, and third platform 14b. The first platform 12 is adjacent to a short side and has a planar upper surface. The first platform 12 can act as a feed platform, wherein the food article to be cut can be placed. For example, the vegetables can be placed on the first platform 12 for cutting. The second platform 14a is adjacent to the first platform 12 and the upper surface of the second platform 14a is also planar. Perhaps, the first platform and the second platform can be integral forming a single unit with a flat surface and a lateral groove 19 differentiate it into the first platform 12 and the second platform 14a. The second platform 14a can be the receiver platform upon which the pieces of the food article be collected. The third platform 14b is adjacent to the second platform 14a and is adjacent to the short side. While the first platform 12 and the second platform 14a are co-planar, the second platform 14a and the third platform are not co-planar, but the third platform 14b slopes downward starting from the side adjacent to the second platform 14a towards the short side of the cutting board 10 forming a ramp. The third platform 14b can be removably coupled to the second platform 14a.

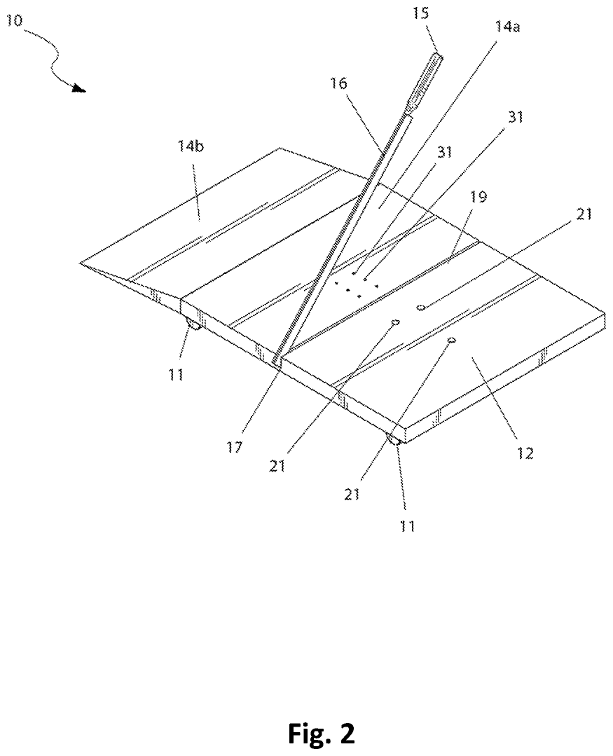

A lateral groove 19 extends between the pair of long sides. A blade 16 can be pivotally coupled to one end of the lateral groove 19, such that the sharp edge of blade 16 lands into the lateral groove 19. As shown in FIG. 1, the blade 16 can have a proximal end and a distal end. The proximal end of the blade 16 can be pivotally coupled to the first end of the lateral groove 19. The first end of the lateral groove 19 is on the left side of the cutting board 10 considering third platform 14b as the front and the first platform 12 as the rear of the cutting board 10. The pivot joint 17 shown in FIG. 2 permits blade 16 to pivot vertically. It will be appreciated by a skilled person that the pivot joint can be provided in one of the different known ways for pivotally mounting a blade to a stationary platform known in the art. For example, a bracket can be coupled to the long side of the cutting board at the first end of the lateral groove 19 to couple the blade 16. The distal end of the blade 16 is provided with an ergonomic handle 15. The handle 15 can be grasped by a hand of a user to pivot the blade against the lateral groove 19. The handle 15 can be made of any suitable material that is both durable and comfortable in the hands of the user. For example, the handle can be made of wood or plastic material. The ergonomic shape of the handle 15 can be configured to provide a better grip and prevent slipping of the hand towards the sharp edge of the blade 16. Further, as shown in FIGS. 1 and 2, the length of the blade between the pivot joint 17 and the handle 15 is equal to or more than the width of the cutting board 10. Additional alternate embodiments may provide for the cutting board 10 to employ a safety bar or locking mechanism to positively lock the blade 16 fully within the lateral groove 19, while the cutting board is not in use or for storage of the cutting board 10.

Further, it is shown in FIG. 1 is a finger guard 20 is mounted on the first platform 12 adjacent to the lateral groove 19. In a preferred embodiment, the finger guard 20 can be positioned centrally, but it is within the scope of the present invention to position the finger guard 20 closer to the left or right long sides of the cutting board 10. The finger guard 20 shown in FIG. 1 is dome-shaped having a curvilinear upper side. The front end and the rear end of the finger guard 20 are open and define a passageway. It can be seen in the drawing that the finger guard is of a substantial frustum conical shape tube, wherein the rear opening can be of a size larger than the front opening. In one case, the rear opening can almost be double the size of the front opening. For example, the front opening can be about 2-4 inches in width and about 1-3 inches in height, and the rear opening can be about 4-6 inches in width and about 3-5 inches in height. For example, the front opening can be about 3 inches in width and about 2 inches in height, and the rear opening can be about 5 inches in width and about 4 inches in height. The larger rear opening may be particularly advantageous for leafy vegetables that allow passing the vegetables through the passageway easier.

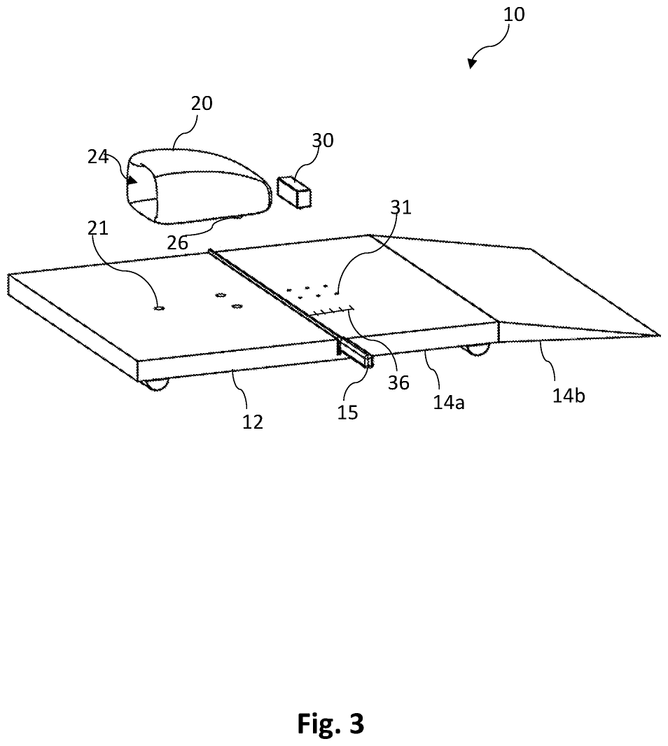

FIG. 1 shows the front opening 22 in front of the finger guard 20. The front opening 22 of the finger guard 20 faces the lateral groove 19. The passageway defined in the finger guard 20 permits a food article to pass through towards the lateral groove 19 but restricts or safeguards a hand/finger from reaching the lateral groove 19. The food article can be inserted from the rear opening 24 (shown in FIG. 3) and through the passageway of the finger guard 20 towards the blade 16, wherein the inserted food article can be cut by the blade 16, while the fingers of the user are safeguarded by the finger guard 20.

In a preferred embodiment, the finger guard 20 can be removably mounted to the cutting board 10, wherein the user can remove the finger guard 20 when not desired. To removably mount the finger guard 20 to the cutting board 10, a coupling mechanism can be provided. FIG. 2 shows an exemplary embodiment of the coupling mechanism, which is a male member 26 (shown in FIG. 3), on the underside of the finger guard 20. Corresponding female member 21 shown in FIG. 2 can be provided on the first platform 12, wherein the male member 26 can releasably couple to the female member 21. In one case, the male member 26 can be pegs and the female member 21 can be apertures. The finger guard can have three such pegs extending downwards from the base of the finger guard and the first platform can have three apertures, wherein the three pegs can insert into the three apertures by friction fit or snap-fit mechanism for securing the finger guard on the first platform of the cutting board. It is understood, however, that two or more pegs in the finger guard and corresponding two or more apertures in the first platform are within the scope of the present invention.

Further is shown in FIG. 1 is a food stopper 30, which is a rectangular shape prism positioned adjacent to the lateral groove 19 and colinear with the finger guard 20. The food stopper 30 provides a barrier to the food article being cut off in order to get consistently sized parts. For example, a user can place the food article against the food stopper 30 and the blade is struck over the food article to divide it into parts. The size of the parts will be proportional to the distance between the lateral groove and the food stopper 30. The food stopper 30 can be used with or without the finger guard 20. The food articles can be inserted from the rear opening of the finger guard 20 towards the food stopper 30 to cut consistently sized food article parts. To further cut off the food article, the remaining portion of the food article can be pushed again towards the food stopper 30, wherein the remaining portion of the food article can push the cut parts to topple over the food stopper 30 and collected behind the food stopper 30. To vary the size of food article parts being cut-off, the position of the food stopper 30 can be varied. As shown in FIGS. 1 and 2, multiple pairs of slots are provided in the second platform 14a. Each pair has two apertures arranged side-by-side and spaced apart from each other. Three pairs of apertures are arranged in a row, wherein adjacent pairs of apertures are spaced apart from each other. The food stopper 30 can be mounted to any of these pairs to increase or decrease the distance of the food stopper 30 from the lateral groove 19 and thus, increase or decrease the size of food article parts being cut off. Additional embodiments may provide for having indicia printed or labeled or otherwise located on the surface of the cutting board 10 adjacent to or aligned with the food stopper 30 to show the exact sizes that the food article can be cut to. The food article parts collected on the second platform 14a can be moved to the third platform 14b for subsequent collection or cooking thereof.

FIGS. 1 and 2 further show a plurality of feet 11 attached, either removably or fixedly, to the underside of the cutting board 10. The cutting board 10 can be placed over a rigid surface, such as kitchen countertops. The feet 11 can be made from a material that is non-slippery and provides stability to the cutting board while cutting the food articles. Preferably four feet can be placed at four corners of the cutting board 10 to ensure even weight distribution and steadiness on the rigid surface when in use. The feet 11 can preferably be made of rubber that is capable of minimal compression and conformity to provide a non-slipping and force absorbing placement on the rigid surface.

Referring to FIG. 3 which shows an exploded view of the cutting board 10. The finger guard 20 can be seen having the rear opening 24, wherein the front opening 22 and the rear opening 24 forms the passageway. The third platform 14b can also be seen removably coupled to the second platform 14a. On the underside of the finger guard 20 can be seen a male mating member 206 that engages with a female mating member, also referred to herein as female member 21. Similarly, the food stopper 30 can have mating members 32 that can engage to the attachment points 31 in the second platform 14a. Also, a measurement scale 36 is shown running along the row of apertures of the food stopper.

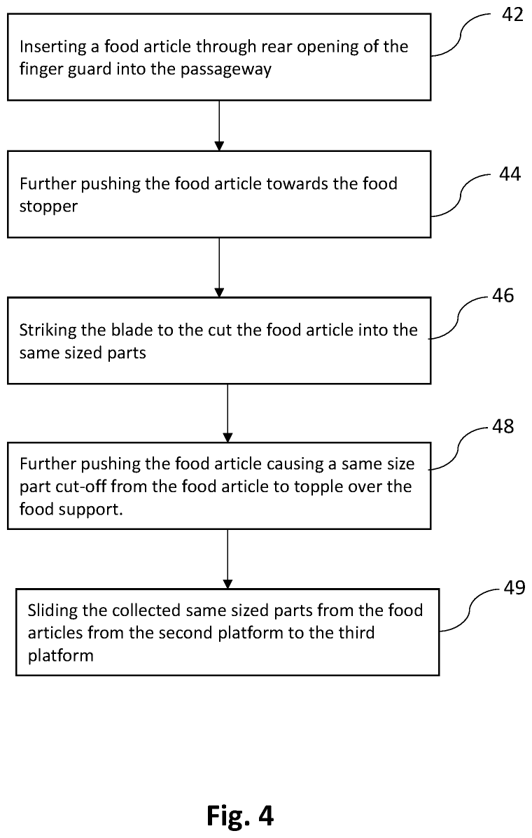

Referring to FIG. 4 which shows a method for cutting the food articles. The food article, such as a vegetable can be inserted through the rear opening 24 of the finger guard 20, wherein the food article passes through the passageway and protrudes through the front opening, at step 42. The food article can be further pushed up to the food support, at step 44. Finally, the blade can be struck, and the process can be repeated to collect the same size parts of the food article. Further pushing of the remaining food article may cause the same size part cut-off from the foot article to topple over the food support, at step 48 and collect behind the food stopper. The collected same size parts of the food articles can slide to the third platform, at step 49.

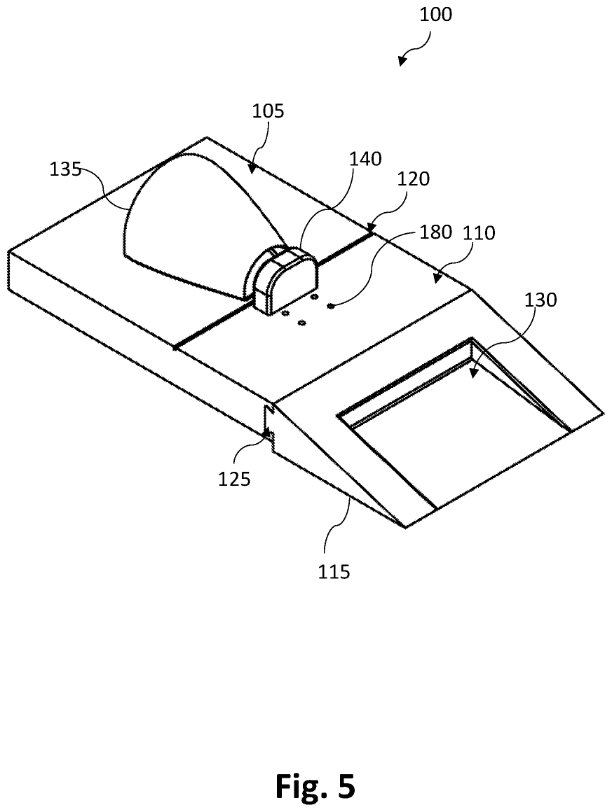

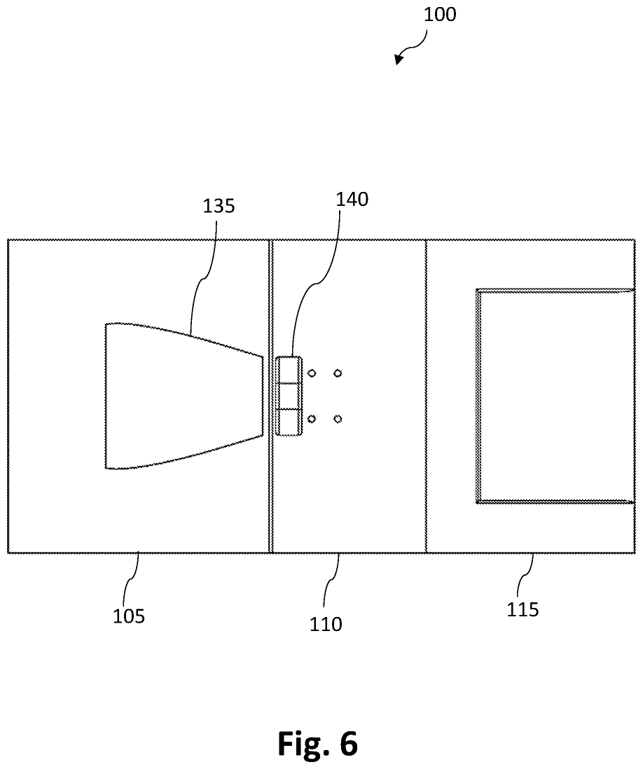

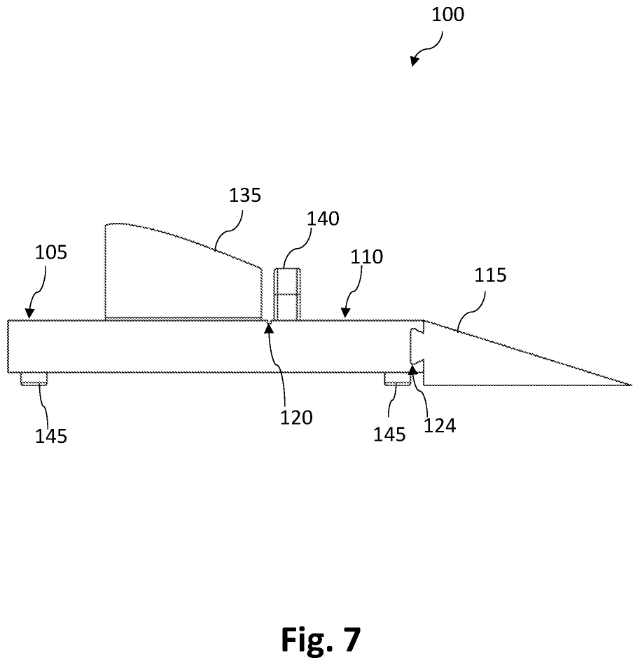

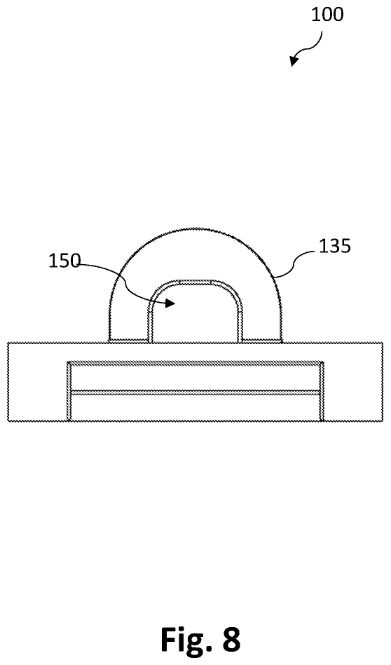

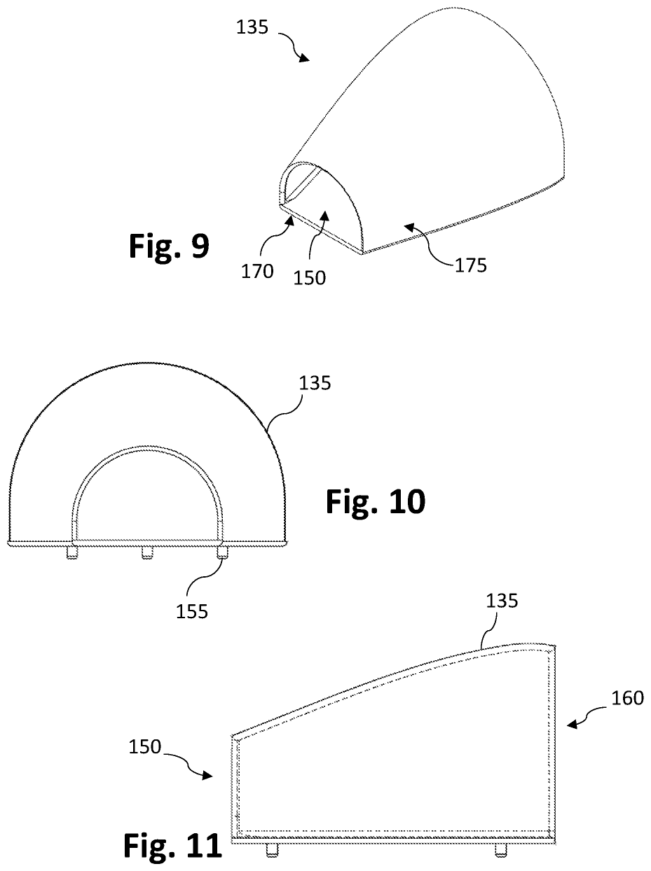

Referring to FIGS. 5-8 which show another embodiment of the cutting board 100 and FIGS. 9-11 which show different views of the finger guard. The cutting board 100 shown in FIG. 9 can be similar to the cutting board 10 shown in FIG. 1, except for the third platform, and hence not described in detail to avoid repetition. Also, it is to be noted that the drawings in FIGS. 5-8 do not show the blade for illustration purposes only, however, the cutting board 100 has a blade similar to the blade 16 shown in FIGS. 1 and 2. The cutting board 100 can include a first platform 105, a second platform 110, and a third platform 115. A traversing lateral groove 120 can be between the first platform and the second platform. FIG. 5 shows a sliding dovetail joint between the third platform and the second platform. However, joints other than the sliding dovetail joint for releasably coupling the third platform to the second platform are within the scope of the present invention. As described for cutting board 10, the third platform 115 shown in FIG. 5 is also sloped downward but includes a cavity 130. Parts of food articles can be collected in cavity 130, wherein cavity 130 can provide a larger volume of holding the pieces of the food article as well as prevent the pieces from dropping off the third platform. A finger guard 135 and a food stopper 140 are also shown in FIG. 5. In one implementation, the cutting board can be about 24 inches in length, and 12 inches in width. The third platform can be about 8 inches in length and about 12 inches in width. The thickness or height of the first platform and the second platform can be about 2 inches. The third platform can be of a right triangle shape, as shown in FIG. 7, wherein an end of the third platform can be pointed. The height of the third platform can be more than the height of the second platform, for example, the height of the third platform can be about 2.5 inches while that of the second platform can be about 2 inches. The larger height of the third platform may provide a larger size cavity and thus more volume for holding the vegetable pieces. To compensate for the gap between the heights of the second platform and the third platform, feet of suitable height can be provided at bottom of the first platform and the second platform. FIG. 7 shows the feet 145 extending downwards from the first platform and the second platform. Four such feet can provide stability to the cutting board while using the cutting board, however, two or more of such feet are within the scope of the present invention. For example, using 0.5 inches feet can make an effective height of the first platform and the second platform of about 2.5 inches which is similar to the height of the third platform.

For use, the user can insert a bunch of leafy vegetables, referred to hereinafter as a bunch, through the rear opening of the finger guard, wherein a tip of the bunch can protrude from the front opening. The bunch can be pushed further toward the food stopper, and when the tip of the bunch touches the food stopper, the blade of the cutting board can be struck to cut a portion of the bunch in pieces. Thereafter, the remaining portion of the bunch can be pushed further towards the food stopper and the steps can be repeated for cutting the bunch into pieces.

An exemplary embodiment of the finger guard 135 is shown in FIGS. 9-11. The finger guard 135 has a front opening 150 and a rear opening 160. The rear opening is of a larger size than the front opening. Also, three pegs 155 are also shown in the drawings that allow mounting the finger guard to the first platform. For example, the apertures 21 shown in FIG. 2 can be used to mount the finger guard, wherein the three pegs can be inserted into the three apertures. The three pegs extend from a base 170 of the finger guard. A cylindrical wall 175 extends upwards from the base to form a tunnel, wherein the passageway of the finger guard passes through the tunnel.

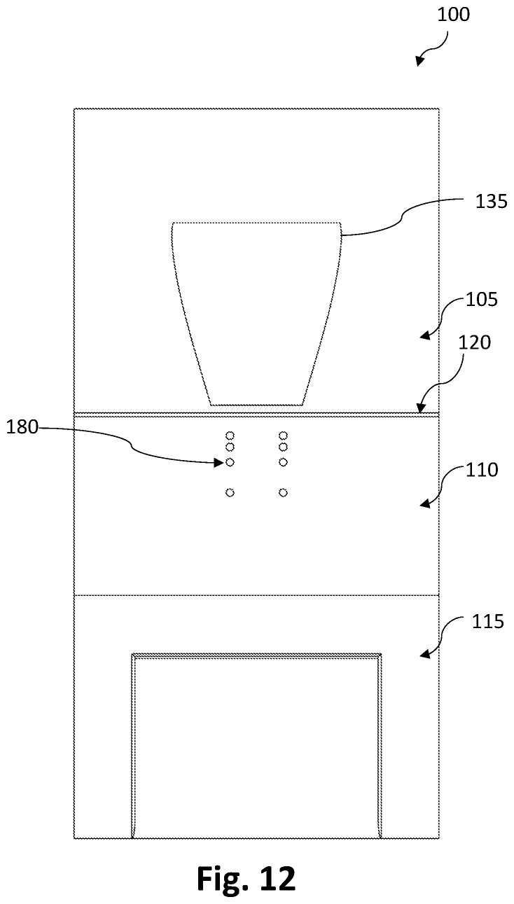

The food stopper 140 can be mounted to the second platform, as shown in FIG. 5. The food stopper and the second platform can have an interlocking mechanism to mount the food stopper to the second platform. The interlocking mechanism can include a male mating member and a female mating member that can interlock, for example, by friction fit or snap-fit mechanism. In one implementation, the food stopper can also have pegs like the food guard as the male mating member, and the second platform can have apertures as the female mating member, the pegs can be inserted into the apertures for locking the food stopper on the second platform, by friction fit or snap fit or like fastening mechanism. While the drawing shows the food stopper having the pegs and the second platform having the apertures, however, it is within the scope of the present invention that the second platform can have the male mating member and the food stopper can have the female mating member of the interlocking mechanism. Referring to FIG. 12, which shows the female mating member 170 in the second platform 110. Each female mating member for the food stopper can have two apertures that correspond to the two pegs of the food stopper. To allow for increasing or decreasing the distance of the food stopper from the lateral groove 120, multiple female mating members can be provided at increasing distances from the lateral groove 120. For example, FIG. 12 shows the four female mating members arranged in a row that extends perpendicular to the lateral groove 120. Also, the distance between two adjacent female mating members can be the same or different in the row.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A cutting board for cutting a food article into parts, the cutting board comprises:
a board that has a first-short side, a second-short side, a first-long side, and a second-long side;
a lateral groove that extends between the first-long side and the second-long side, the lateral groove differentiates the board into a first platform and a second platform, the lateral groove has a first end and an opposite second end;
a blade that has a proximal end and a distal end, the proximal end of the blade is pivotally coupled to the first end of the lateral groove and the distal end of the blade has a handle;
a finger guard removably mounted to the first platform and adjacent to the lateral groove, the finger guard has a flat base and a cylindrical wall upstand from the flat base forming a tunnel, wherein the finger guard has a front opening and a rear opening, a size of the rear opening is larger than a size of the front opening; and
a food stopper mounted to the second platform and adjacent to the lateral groove and in front of the front opening of the finger guard such that the food stopper is capable of limiting movement of a food article being inserted through the rear opening and protruding from the front opening of the finger guard.

2. The cutting board of claim 1, wherein a size of the rear opening is about double a size of the front opening.

3. The cutting board of claim 4, wherein the size of the rear opening is double the size of the front opening.

4. The cutting board of claim 1, wherein the second platform has a plurality of attachments, each attachment of the plurality of attachments configured to engage the food stopper, wherein the plurality of attachments are arranged in a row at spaced intervals, wherein the row extends perpendicular to the lateral groove.

5. The cutting board of claim 1, wherein the board further comprises a third platform, wherein the third platform is removably coupled to the second platform, wherein the third platform has a cavity of storing parts of the food article.

6. The cutting board of claim 1, wherein the cutting board further comprises a locking mechanism configured to secure the blade within the lateral groove preventing the pivoting of the blade.

7. A method of cutting a food article into parts, the method comprises:
providing a cutting board, the cutting board comprising:
a board that has a first-short side, a second-short side, a first-long side, and a second-long side,
a lateral groove that extends between the first-long side and the second-long side, the lateral groove differentiates the board into a first platform and a second platform, the lateral groove has a first end and an opposite second end,
a third platform removably coupled to the second platform, wherein the third platform has a cavity of storing parts of the food article,
a blade that has a proximal end and a distal end, the proximal end of the blade is pivotally coupled to the first end of the lateral groove and the distal end of the blade has a handle,
a finger guard removably mounted to the first platform and adjacent to the lateral groove, the finger guard has a flat base and a cylindrical wall upstand from the flat base forming a tunnel, wherein the finger guard has a front opening and a rear opening, a size of the rear opening is larger than a size of the front opening, and
a food stopper mounted to the second platform and adjacent to the lateral groove and in front of the front opening of the finger guard such that the food stopper is capable of limiting movement of a food article being inserted through the rear opening and protruding from the front opening of the finger guard;
inserting the food article through the rear opening and towards the food stopper;
striking the blade to cut-off a portion of the food article into parts; and
moving the parts from the second platform to the third platform.

8. The method of claim 7, wherein the second platform further comprises a plurality of attachment members arranged in a row at spaced intervals, the row extends perpendicular and away from the lateral groove, the food stopper mounted to the second platform at one of the plurality of attachment members, and wherein the method further comprises the step of:
mounting the food stopper to a first attachment member of the plurality of attachment members;
removing the food stopper from the first attachment member; and
upon removing, mounting the food stopper to a second attachment member of the plurality of attachment members.

9. The method of claim 7, wherein the food article is a bunch of leafy vegetable.

10. The method of claim 7, wherein a size of the rear opening is about double a size of the front opening.

11. The method of claim 10, wherein the size of the rear opening is double the size of the front opening.
